(19) United States
(12) Patent Application Publication
(10) Pub. No.: US 2014/0334369 A1
(43) Pub. Date: Nov. 13, 2014

(54) RADIO USAGE OPTIMIZATION WITH INTERMITTENT TRAFFIC

(71) Applicant: Nokia Corporation, Espoo (FI)

(72) Inventors: Jorma Kaikkonen, Oulu (FI); Jussi-Pekka Koskinen, Oulu (FI); Ilkka Keskitalo, Oulu (FI); Lars Dalsgaard, Oulu (FI)

(21) Appl. No.: 14/358,145

(22) PCT Filed: Nov. 14, 2012
(86) PCT No.: PCT/FI2012/051106

§ 371 Date: May 14, 2014

Related U.S. Application Data
(60) Provisional application No. 61/559,888, filed on Nov. 15, 2011.

(51) Int. Cl. H04W 52/02; H04W 76/06; H04W 76/04

(52) U.S. Cl. CPC H04W 52/0212; H04W 76/048; H04W 76/068
USPC 370/311

(57) ABSTRACT

In accordance with the exemplary embodiments of the invention there is at least a method and apparatus to perform a method of determining assistance information associated with intermittent background traffic of at least one of applications and services running on user equipment, and sending said assistance information towards a serving network element. Further, in accordance with the exemplary embodiments of the invention there is at least a method and apparatus to perform a method of receiving signaling at a user equipment from a radio access network, the signaling indicating an interval when the user equipment can at least one of transmit and receive intermittent background traffic associated with at least one of applications and services miming on the user equipment, and performing an access from an idle state at the indicated interval.

### TECHNICAL FIELD

The exemplary and non-limiting embodiments of this invention relate generally to wireless communication systems, methods, devices and computer programs and, more specifically, relate to methods and apparatus to optimize the transmission of intermittent traffic, also referred to as background (BG) traffic, from a mobile communication device to a wireless network.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
3GPP third generation partnership project
API application program interface
AS access stratum
BG background
BS base station
DL downlink (eNB towards UE)
DRX discontinuous reception
eNB E-UTRAN Node B (evolved Node B)
EPC evolved packet core
E-UTRAN evolved UTRAN (LTE)
FDMA frequency division multiple access
IMTA international mobile telecommunications association
ITU-R international telecommunication union-radiocommunication sector
LTE long term evolution of UTRAN (E-UTRAN)
LTE-A LTE advanced
MAC medium access control (layer 2, L2)
MM/MME mobility management/mobility management entity
NAS non-access stratum
NodeB base station
OFDMA orthogonal frequency division multiple access
O&M operations and maintenance
PDCP packet data convergence protocol
PHY physical (layer 1, L1)
Rel release
RLC radio link control
RRC radio resource control
RRM radio resource management
SGW serving gateway
SC-FDMA single carrier, frequency division multiple access
UE user equipment, such as a mobile station, mobile node or mobile terminal
UL uplink (UE towards eNB)
UPE user plane entity
UTRAN universal terrestrial radio access network

One modem communication system is known as evolved UTRAN (E-UTRAN, also referred to as UTRAN-LTE or as E-UTRA),In this system the DL access technique is OFDMA, and the UL access technique is SC-FDMA.

One specification of interest is 3GPP TS 36.300 V10.5.0 (2011-09) Technical Specification 3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 10) incorporated by reference herein in its entirety and referred to for simplicity hereafter as 3GPP TS 36.300.

FIG. 1 reproduces FIG. 4.1 of 3GPP TS 36.300 and shows the overall architecture of the EUTRAN system (Rel-8). The E-UTRAN system includes eNBs, providing the E-UTRAN user plane (PDCP/RLC/MAC/PHY) and control plane (RRC) protocol terminations towards the UEs. The eNBs are interconnected with each other by means of an X2 interface. The eNBs are also connected by means of an S1 interface to an EPC, more specifically to a MME by means of a S1 MME interface and to a S-GW by means of a S1 interface (MME/S-GW 4). The S1 interface supports a many-to-many relationship between MMEs/S-GWs/UPEs and eNBs.

The eNB hosts the following functions:

functions for RRM: RRC, Radio Admission Control, Connection Mobility Control, Dynamic allocation of resources to UEs in both UL and DL (scheduling);
IP header compression and encryption of the user data stream;
selection of a MME at UE attachment;
routing of User Plane data towards the EPC (MME/S-GW);
scheduling and transmission of paging messages (originated from the MME);
scheduling and transmission of broadcast information (originated from the MME or O&M); and
a measurement and measurement reporting configuration for mobility and scheduling.

Also of interest herein are the further releases of 3GPP LTE (e.g., LTE Rel-10) targeted towards future IMT-A systems, referred to herein for convenience simply as LTE-Advanced (LTE-A).

Reference in this regard may be made to 3GPP TR 36.913 V 10.0.0 (2011-03) Technical Report 3rd Generation Partnership Project; Technical Specification Group Radio Access Network; Requirements for further advancements for Evolved Universal Terrestrial Radio Access (E-UTRA) (LTE-Advanced) (Release 10). Reference can also be made to 3GPP TR 36.912 V10.0.0 (2011-03) Technical Report 3rd Generation Partnership Project; Technical Specification Group Radio Access Network; Feasibility study for Further Advancements for E-UTRA (LTE-Advanced) (Release 10).

A goal of LTE-A is to provide significantly enhanced services by means of higher data rates and lower latency with reduced cost. LTE-A is directed toward extending and optimizing the 3GPP LTE Rel-8 radio access technologies to provide higher data rates at lower cost. LTE-A will be a more optimized radio system fulfilling the ITU-R requirements for IMT-Advanced while keeping the backward compatibility with LTE Rel-8.

Evolving networks and new types of terminals (e.g., UEs), particularly smart phone type of terminals, are gradually changing the characteristics of mobile traffic. As time progresses it can be expected that there will be more applications requiring some type of always-on connection(s). This trend gives rise to a number of challenges both in regards to the radio access network load as well as in the terminal. For example, the network will need to accommodate issues with signaling load caused by a large number of simultaneously connected UEs and/or UEs changing state between idle and connected states.

In addition, smart phones can generate traffic also when unattended if certain applications are launched. These certain applications can generate ‘keep-alive’ traffic, and can also generate and receive status updates or similar traffic which typically consists of small packets (or bursts of packets) that are sent intermittently. This type of traffic is often referred to as background (BG) traffic. The background traffic can include, as examples, polling messages, keep-alive messages, status updates, update queries, and/or other types of traffic that the applications, or operating system, are generating when the terminal is not actively being used.

### SUMMARY

In an exemplary aspect of the invention, there is a method comprising method comprising: determining assistance information associated with intermittent background traffic of at least one of applications and services running on a user equipment; and sending said assistance information towards a serving network element.

In another exemplary aspect of the invention, there is an apparatus comprising at least one processor; and at least one memory including computer program code, where the at least one memory and the computer program code are configured, with the at least one processor, to cause the apparatus to at least: determine assistance information associated with intermittent background traffic of at least one of applications and services running on a user equipment; and send said assistance information towards a serving network element.

In another exemplary aspect of the invention, there is an apparatus comprising means for determining assistance information associated with intermittent background traffic of at least one of applications and services running on a user equipment; and means for sending said assistance information towards a serving network element.

In accordance with the paragraph above the means for sending and the means for performing comprises an interface to a radio access network, a non-transitory computer-readable medium including software program instructions, and the software program instructions executed by at least one data processor.

### BRIEF DESCRIPTION OF THE DRAWINGS

In the attached Drawing Figures:

FIG. 1 reproduces FIG. 4.1 of 3GPP TS 36.300, and shows the overall architecture of the EUTRAN system.

FIG. 2 shows a simplified block diagram of various electronic devices that are suitable for use in practicing the exemplary embodiments of this invention.

FIGS. 3A-3D, collectively referred to as FIG. 3, show various simulation results from R2-115931 (the Appendix of R2-115931 lists the simulation parameters) where:

FIG. 3A shows mean power consumption of background traffic with different UE velocities and RRC release timer values, no DRX;

FIG. 3B shows mean power consumption with different DRX long cycle lengths and different RRC release timer values, background traffic model with 30 s inter-burst arrival time, UE velocity of 3 km/h;

FIG. 3C shows mean power consumption with different intervals of traffic bursts and different RRC release timers, DRX cycle length of 160 ms, UE speed of 30 km/h; and

FIG. 3D shows a number of RRC messages per cell per second for different RRC release timer and DRX long cycle lengths, 30 km/h.

FIGS. 4, 5, 6, 7, 8 and 9 are each a logic flow diagram that illustrates the operation of a method, and a result of execution of computer program instructions embodied on a computer readable medium, in accordance with the exemplary embodiments of this invention.

### DETAILED DESCRIPTION

Of interest in the following discussion is 3GPP TS 36.331 V10.3.0 (2011-09) Technical Specification 3rd Generation Partnership Project; Technical Specification Group Radio Access Network; Evolved Universal Terrestrial Radio Access (E-UTRA); Radio Resource Control (RRC); Protocol specification (Release 10), such as Section 5.3, Connection Control.

Also of interest in the following discussion is 3GPP TS 36.321 V10.3.0 (2011-09) Technical Specification 3rd Generation Partnership Project; Technical Specification Group Radio Access Network; Evolved Universal Terrestrial Radio Access (E-UTRA); Medium Access Control (MAC) protocol specification (Release 10). For example, one section of interest is Section 5.7, Discontinuous Reception (DRX).

Corresponding UTRAN specifications are 3GPP TS 25.331 V10.5.0 (2011-09) Technical Specification 3rd Generation Partnership Project; Technical Specification Group Radio Access Network; Radio Resource Control (RRC); Protocol specification (Release 10), and 3GPP TS 25.321 V10.4.0 (2011-09) Technical Specification 3rd Generation Partnership Project; Technical Specification Group Radio Access Network; Medium Access Control (MAC) protocol specification (Release 10), respectively.

It would be desirable to minimize the impact from the transmission of intermittent small back ground packets on the UE power consumption, with a goal being to have the power consumption approach that of when the UE is operating in the idle state. This could be accomplished by either moving the UE to the idle state very soon after sending/receiving a data burst, or by configuring the UE with appropriate connected mode DRX parameters allowing sufficient “sleep” times at the UE.

In LTE networks the state transitions between idle and connected, as well as connected mode DRX, are controlled by the network. To achieve optimum operation both from the UE and the network perspective will require more sophisticated features to be specified.

In 3GPP there has been a work item entitled “Enhancements for Diverse Data Applications (EDDA)” which addresses these kinds of issues and where potential new standards for smart phone operation will be specified.

In smart phone operating systems there are functions that can organize the time-based activities of services such as email synchronization, status updates and synchronization of social networks/media. The time-based activities of the individual application/services can be organized so that rather than each individual application contacting the (cellular) network separately during different cycles, these contacts are coordinated in a centralized manner in a connection scheduler function. For example, in the Symbian™ operating system there is a function, FlexTimer (similar functions exist for other operating systems), that can collect and coordinate the required updates and other traffic from multiple delay tolerant applications and process them all during one common activity/access burst. The delay tolerance depends on the application itself. Application developers may utilize the features in the API to support such optimization function by defining the delay requirement of a certain data transfer. This can be especially relevant and useful for BG traffic where the delays typically do not affect the user experience.

UEs that are connecting to the network for intermittent (e.g., background) traffic without any alignment (transmitted immediately when uplink packet becomes available for transmission or pinging updates independently), and some operating systems, may collect several packets and transmit these using a time interval determined by the UE (device) itself.

Frequent transmission of BG-type of traffic can cause a problem for the system or network performance. For example, the network problems can include signaling load problems caused by RRC state changes (idle state to connected state transitions and vice versa) and/or frequent handover related signaling problems if the network keeps the UE in the connected state.

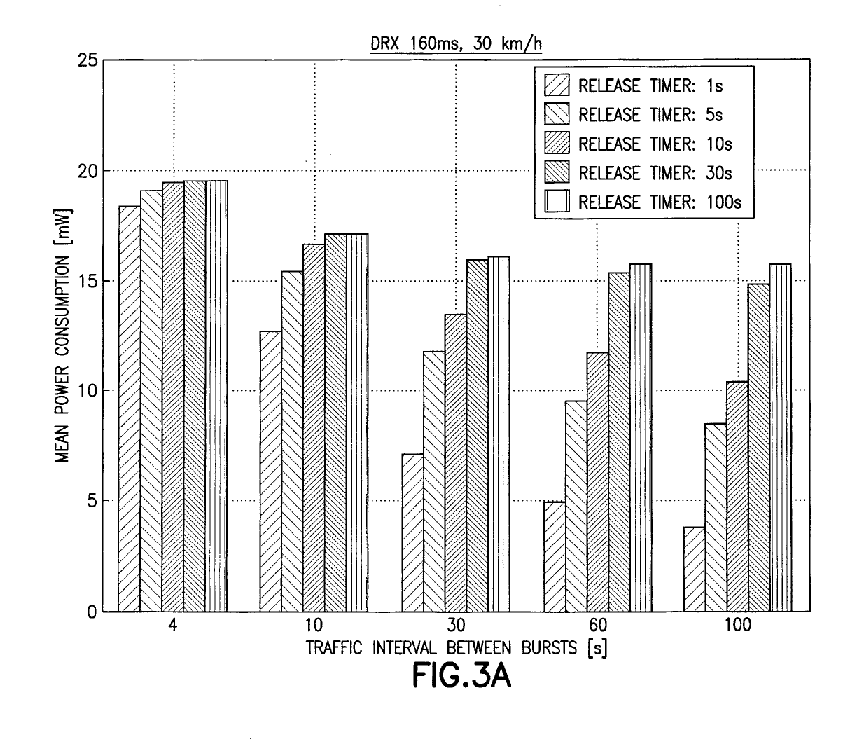

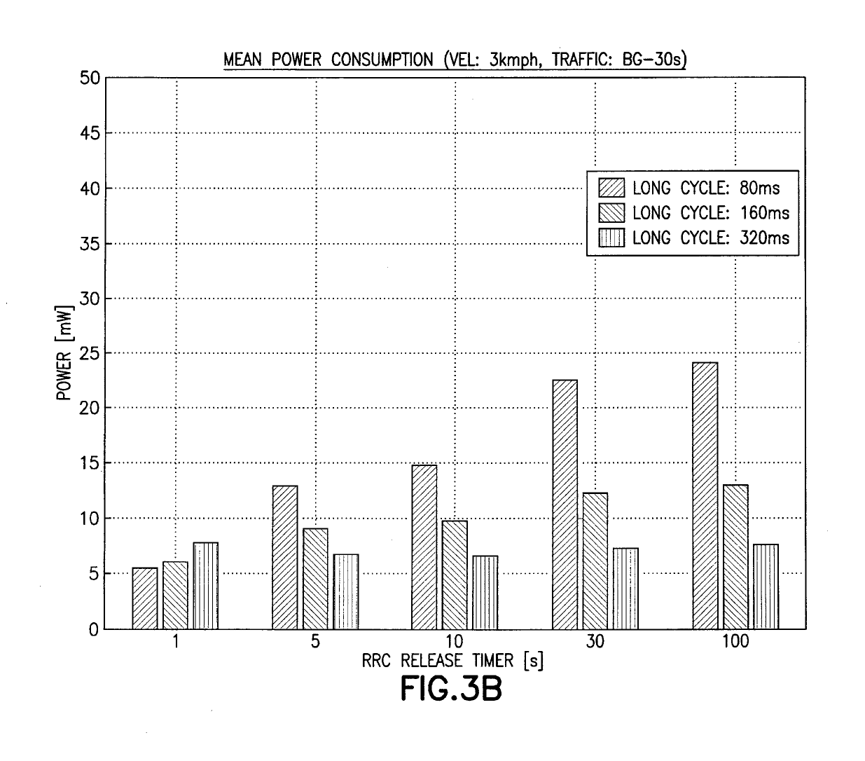

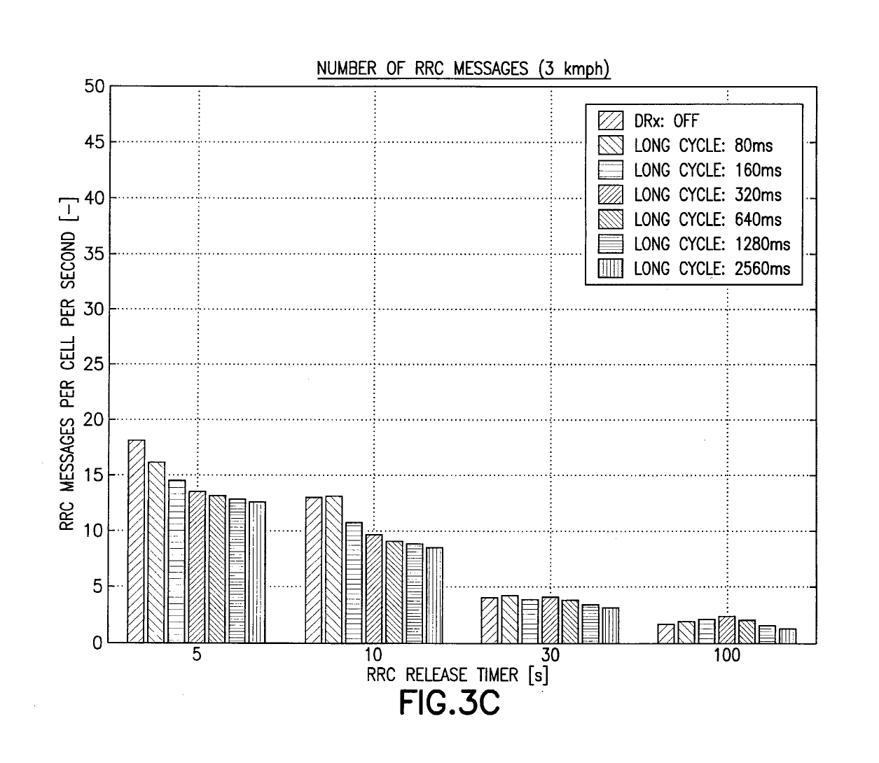

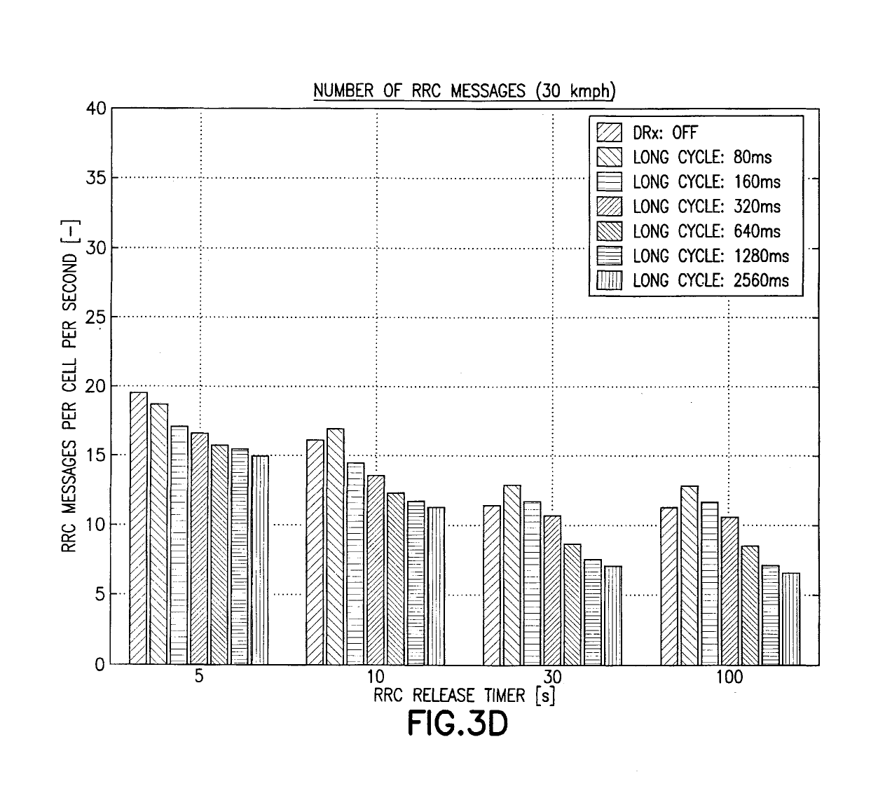

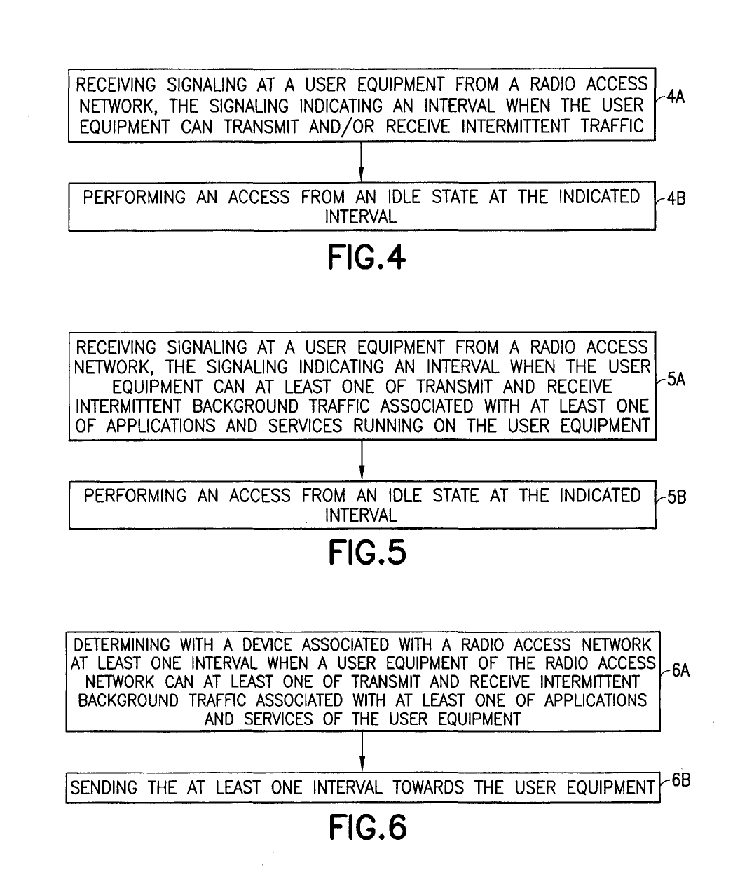

FIG. 3A shows simulated results based on those found in 3GPP TSG-RAN WG2 Meeting #7, R2-115931, San Francisco, USA, 14-18 Nov. 2011, Source: Nokia Corporation, Nokia Siemens Networks, Title: Power consumption and signalling load for background traffic. This Figure illustrates the impact on the UE power consumption with different packet transmission intervals.

While the state transitions and DRX configuration are under control of the radio access network (RAN), which is the case in LTE as well as in 2G and 3G RANs, the network does not have explicit knowledge about the characteristics of the instantaneous traffic and connection needs, e.g. whether the traffic is BG traffic or is traffic generated by active usage of a certain application. Nor is the network aware of any intermediate functions that will affect the usage of radio connection. As a result there is no possibility with current specifications to reach optimum operation with respect to network signaling and UE power consumption (as well as the user experience) when the nature of the traffic is not known.

As a result of this knowledge deficiency at the RAN, one challenge is to determine when to release the connection and/or what kind of connected mode DRX configuration would be most optimum for given traffic characteristics and requirements.

FIG. 3B illustrates the UE power consumption as a function of release timer value with various DRX configurations.

FIG. 3C shows a number of RRC messages per cell per second for different RRC release timer and DRX long cycle lengths, 3 km/h, while FIG. 3D shows the number of RRC messages per cell per second for different RRC release timer and DRX long cycle lengths, 30 km/h.

The RAN can monitor the generated traffic and based on historical data can determine what type of DRX parameters could be used. To control the state transitions the RAN may have a “global” value for a connection release timer. The connection release timer is started when a data transfer ends and when the timer expires the UE is transitioned to the idle state. The release timer value may have the same value for all UEs regardless of the traffic situation, mobility, or other parameters. This conventional use of the connection release timer is thus not adequate to deal with the challenges presented by modern smart phone and other types of UEs that can generate significant amounts of variable BG traffic.

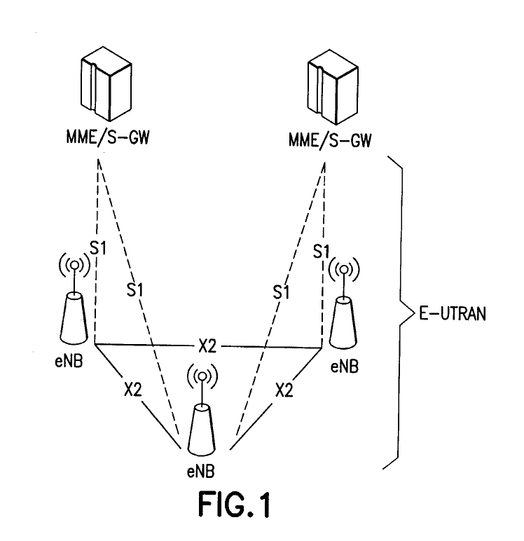

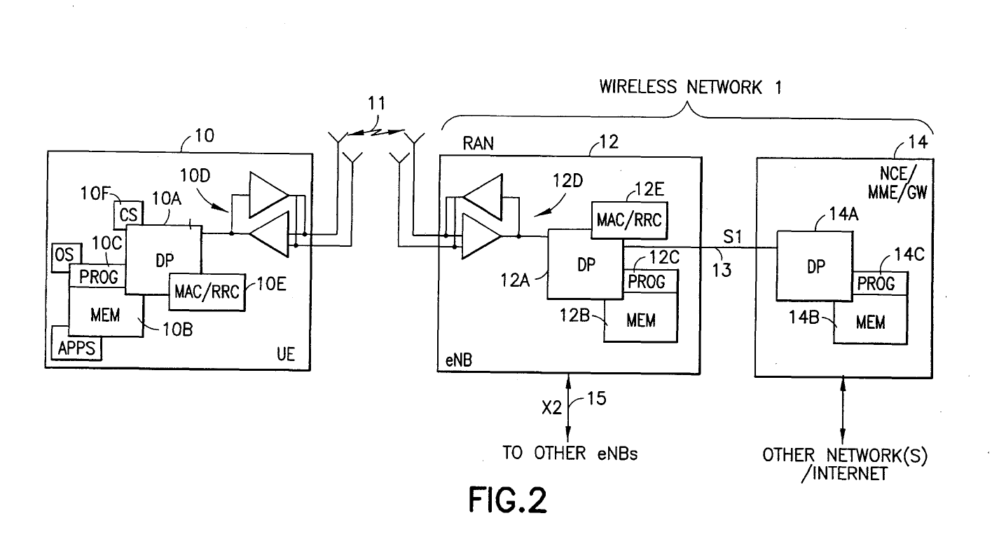

Before describing in further detail the exemplary embodiments of this invention, reference is made to FIG. 2 for illustrating a simplified block diagram of various electronic devices and apparatus that are suitable for use in practicing the exemplary embodiments of this invention. In FIG. 2 a wireless network 1 is adapted for communication over a wireless link 11 with an apparatus, such as a mobile communication device which may be referred to as a UE 10, via a network access node, such as a Node B (base station), and more specifically an eNB 12 that is associated with a RAN. The network 1 may include a network control element (NCE) 14 that may include the MME/SGW functionality shown in FIG. 1, and which provides connectivity with a further network, such as a telephone network and/or a data communications network (e.g., the internet). The UE 10 includes a controller, such as at least one computer or a data processor (DP) 10A, at least one non-transitory computer-readable memory medium embodied as a memory (MEM) 10B that stores a program of computer instructions (PROG) 10C. The program 10C can include an operating system (OS). Other programs, including applications (APPS) are also stored in the memory 10B. The UE 10 also includes at least one suitable radio frequency (RF) transmitter and receiver pair (transceiver) 10D for bidirectional wireless communications with the eNB 12 via one or more antennas. The transceiver 10D can be assumed to be associated with a modulator/demodulator (modem) functionality of the UE 10.

The eNB 12 also includes a controller, such as at least one computer or a data processor (DP) 12A, at least one computer-readable memory medium embodied as a memory (MEM) 12B that stores a program of computer instructions (PROG) 12C, and at least one suitable RF transceiver 12D for communication with the UE 10 via one or more antennas (typically several when multiple input/multiple output (MIMO) operation is in use). The eNB 12 is coupled via a data/control path 13 to the NCE 14. The path 13 may be implemented as the 51 interface shown in FIG. 1. The eNB 12 may also be coupled to another eNB via data/control path 15, which may be implemented as the X2 interface shown in FIG. 1.

The NCE/MME/GW 14 also includes a controller, such as at least one computer or a data processor (DP) 14A, at least one computer-readable memory medium embodied as a memory (MEM) 14B that stores a program of computer instructions (PROG) 14C.

For the purposes of describing the exemplary embodiments of this invention the UE 10 can be assumed to also include at least MAC and RRC (including timer(s)) functionality 10E, and the eNB 12 can also be assumed to include MAC and RRC functionality 12E. The UE 10 can also include a connection scheduler (CS) functionality 10F as described in further detail below.

At least one of the PROGs 10C and 12C is assumed to include program instructions that, when executed by the associated DP, enable the device to operate in accordance with the exemplary embodiments of this invention, as will be discussed below in greater detail. That is, the exemplary embodiments of this invention may be implemented at least in part by computer software executable by the DP 10A of the UE 10 and/or by the DP 12A of the eNB 12, or by hardware, or by a combination of software and hardware (and firmware).

The various data processors, memories, programs, transceivers and interfaces depicted in FIG. 2 can all be considered to represent means for performing operations and functions that implement the several non-limiting aspects and embodiments of this invention.

In general, the various embodiments of the UE 10 can include, but are not limited to, cellular mobile devices such as so-called smart phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer-readable MEMs 10B and 12B may be of any type suitable to the local technical environment and may be implemented using any suitable data storage technology, such as semiconductor based memory devices, random access memory, read only memory, programmable read only memory, flash memory, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on multi-core processor architectures, as non-limiting examples.

In accordance with the exemplary embodiments of this invention the network 1 informs the UE 10 of a time period that would be a minimum interval for transmitting intermittent (e.g. background) traffic. This results in optimized network performance and UE 10 battery consumption. The UE 10, having knowledge that it currently has only BG traffic (or some other type of low priority traffic) uses the signaled time period without degrading the user experience.

In one embodiment in E-UTRAN the RAN can send the time period value to the UE 10 via RRC signaling. The new information element could be included in, for example, the RRCConnectionReConfigur§ation message, e.g., in the same way as the DRX configuration is done using the MAC-MainConfig information element. In addition or alternatively, broadcast signaling could be used to inform the UE 10 about the timer value. One of the system information blocks (SIB) can be used to convey the information. The time value could be also sent on both dedicated RRC signaling and broadcast signaling, where the default value is given in the broadcast message and a dedicated value, when needed, e.g., a user specific value, can be given in the dedicated RRC signaling. The timer value could be sent also using MAC signaling.

Yet another alternative is to link the timer value to a subscription class. The network can signal multiple timer values and the selection of the timer value applied at the UE could be based on, for example, the subscription class of the UE, or it could be based on UE power consumption profile, or, the user could select an appropriate value from a list provided by the network. The subscriptions class itself could have a specific value for the timer and the radio signaling could be basically omitted.

By whatever means the UE 10 is informed of the timer value the UE 10 only performs an access from the (RRC) idle state at certain specific intervals/points in time. The rules and access restrictions can be based on network configuration and can only apply for certain services or application types, e.g., based on priority.

The UE 10 can also indicate to the network 1 when it only has background traffic ongoing. In addition, the UE 10 can propose to the network 1 a suitable range or value for the interval for transmitting intermittent (e.g., background) traffic. Based on this information, and possibly combining this information with other information (e.g., mobility state or UE velocity), the network 1 can determine to either use reduced connection release timer values (UE-specific values), or the network 1 can configure the DRX with suitable parameter values. In this case the optimized release timer value and/or DRX parameter values depend on the packet/burst interval that is generated by the application or applications being executed at the UE 10. This information can be used by the network 1 for configuring the UE 10 to obtain an optimum transmission interval assuming that use of this interval leads to both UE 10 and network 1 optimized behavior.

The signaled optimum time interval for BG application updates (download or upload) could also be given by the network 1 by providing multiple values from which the UE 10, depending on those applications that are currently running, can select one value that is best suited for current traffic. If there are some discrete values standardized for the BG transmission interval, the applications can be developed in a manner that considers one or several specific values to be most suitable for the application.

The connection scheduler function 10F of the UE 10, which can be associated with the UE operating system (OS) and that can coordinate the update cycles for multiple services, could also take the value of the network signaled transmission interval into account when determining the possible cycles for awakening access (e.g., cellular/WLAN). The connection scheduler function 10F could also reside in the modem of the UE 10 if not resident in the OS. The UE 10 implementation preferably also supports the sharing of the related radio access parameters (e.g., the signaled optimum time interval for data transmissions) to the connection scheduler function 10F.

The UE 10 can indicate about the traffic type (BG or non-BG traffic) either at every data transmission, or the indication could be in the form of ‘start-of-BG/end-of-BG traffic’. Other alternative implementations can also be used.

The UE 10 implementation preferably also supports the sharing of the traffic type from the application or the connection scheduler function 10F to the modem which would then be able to inform the RAN about the nature of the traffic. This type of operation could possibly require specific features to be supported by the service APIs so that the application developers could consider what kind of traffic is generated in different situations. Also, an indication of the delay tolerance allowed for the application data transfer can consider the assumed values for network suggested transmission intervals, or a data collection function could consider this issue.

The NAS layer (in network 1 and/or UE 10 side) may also be involved with changing information between the AS and application layer. Typically the NAS layer has certain requirements, such as latency, throughput, etc. available concerning the ongoing traffic. The AS layer of the UE 10 and/or the network 1 can then use this information for determining the suitable minimum interval for transmitting intermittent (e.g., background) traffic

The non-access stratum (NAS) forms the highest stratum of the control plane between the UE and MME at the radio interface (“LTE-Uu interface”). Functions of the protocols that are part of the NAS include support of mobility of the UE and support of session management procedures to establish and maintain IP connectivity between the UE and a packet data network gateway (PDN GW). General reference can be made to 3GPP TS 24.301 V11.0.0 (2011-09) Technical Specification 3rd Generation Partnership Project; Technical Specification Group Core Network and Terminals; Non-Access-Stratum (NAS) protocol for Evolved Packet System (EPS); Stage 3 (Release 11).

The following presents one one non-limiting example of how the features of this invention could be utilized by the network 1 and the UE 10 (not all listed steps are mandatory).

A. The network 1 signals an optimum time interval (e.g., in dedicated or broadcast signaling) for background data updates. Related to this the UE 10 can also inform the network 1 of a data activity mode of the UE 10 (background or active mode). The network 1 can use the UE 10 data activity mode information for determining a suitable packet transmission interval and possibly use the UE 10 mobility state and/or network load circumstances for determining a suitable packet transmission interval.

B. When coordinating UE 10 initiated connection requests from different applications the UE 10 takes into account the network signaled value when determining suitable/possible update time intervals.

C. The UE 10 initiates a connection to receive/transmit intermittent updates at the earliest when a timer related to the cycle has expired, or by synchronizing the transmission with the higher priority traffic that the UE possibly has.

D. The network 1 can use, for example, the UE 10 mobility state and/or the UE 10 data activity mode information and/or network load circumstances to determine suitable handling of the connection, e.g., if the connection would be beneficial to release or not, or determine the value for the release timer. Also a suitable DRX configuration could be considered by the network.

The use of the exemplary embodiments of this invention enables an optimized usage of the radio channel with minimized network signaling load and UE power consumption. The use of the exemplary embodiments of this invention also enables improved operation of smart phones, and provides longest possible stand-by times without sacrificing the user experience (when non-background traffic is needed to be transmitted/received). The use of the exemplary embodiments of this invention further enables a minimized signaling load in the network 1 (as a function of network configuration and algorithms), as well as enabling the development of smart phone applications and/or implementation of a connection scheduling function in a manner that takes the radio usage into account.

Based on the foregoing it should be apparent that the exemplary embodiments of this invention provide a method, apparatus and computer program(s) to optimize transmission/reception of back ground and other intermittent traffic between the user equipment and the RAN.

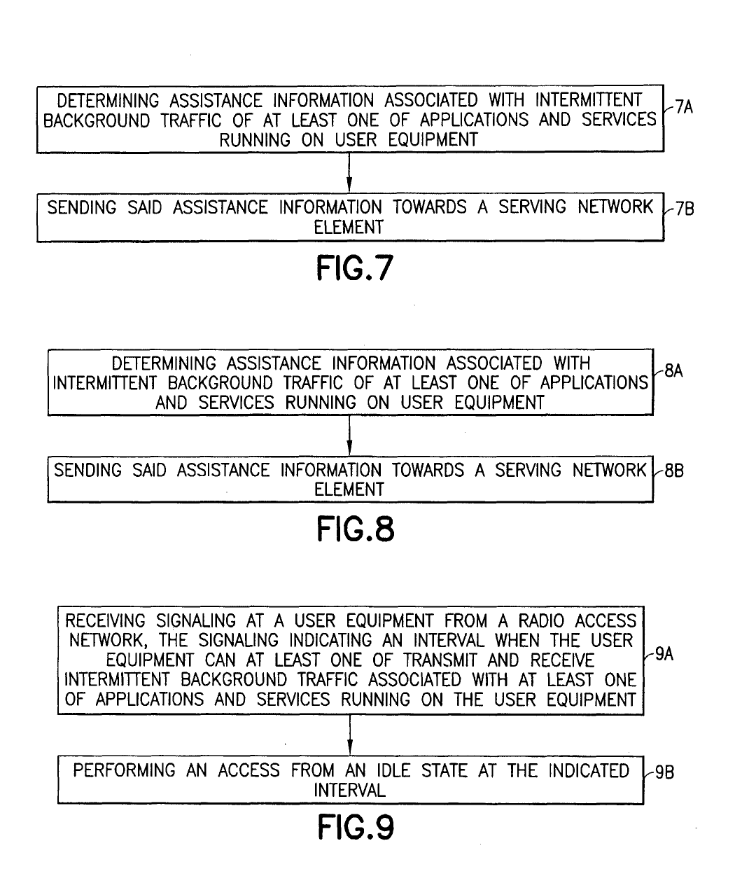

FIG. 4 is a logic flow diagram that illustrates the operation of a method, and a result of execution of computer program instructions, in accordance with the exemplary embodiments of this invention. In accordance with these exemplary embodiments a method performs, at Block 4A, a step of receiving signaling at a user equipment from a radio access network, the signaling indicating an interval when the user equipment can transmit and/or receive intermittent traffic. At Block 4B there is a step of performing an access from an idle state at the indicated interval.

The method of FIG. 4, where when performing the access the user equipment transmits intermittent traffic arising from one or more sources, such as one or more applications or services, in the user equipment.

The method of FIG. 4, where access rules and access restrictions are based on a radio access network configuration.

The method of FIG. 4 and the preceding paragraph, where the access rules and access restrictions are applicable for only certain services and/or application types that execute in the user equipment.

The method of FIG. 4, and further comprising a step of sending an indication to the radio access network to indicate when the user equipment has intermittent traffic to send to the network.

The method of FIG. 4, and further comprising a step of sending a proposal to the radio access network to suggest a range or a value for the interval for transmitting intermittent traffic.

The method of FIG. 4 and the preceding paragraph, where the radio access network uses the proposal in combination with other user equipment related information to at least one of determine a connection release timer value and discontinuous reception parameter values.

The method of FIG. 4, where the interval received by the user equipment is one of a plurality of possible intervals suggested by the radio access network, and further comprising a step of selecting one of the possible intervals that is currently best suited for accommodating the intermittent traffic of the user equipment.

The method of FIG. 4, where a connection scheduler function of the user equipment considers the received interval when scheduling intermittent traffic needed by services and applications executing in the user equipment.

The method of FIG. 4, where the user equipment when transmitting traffic indicates to the radio access network a type of traffic being transmitted.

The method of FIG. 4 and the preceding paragraph, where the type of traffic is indicated by a connection scheduler function of the user equipment.

The method of FIG. 4, where the interval is based at least in part on a subscription associated with the user equipment.

The method of FIG. 4, where the signaling is comprised of at least one of RRC signaling and MAC signaling.

The method of FIG. 4, where the signaling is comprised of broadcast signaling.

A non-transitory computer-readable medium that contains software program instructions, where execution of the software program instructions by at least one data processor results in performance of operations that comprise execution of the method of FIG. 4 and the foregoing several paragraphs descriptive of FIG. 4.

FIG. 5 is a logic flow diagram that illustrates the operation of a method, and a result of execution of computer program instructions, in accordance with the exemplary embodiments of this invention. In accordance with these exemplary embodiments a method performs, at Block 5A, a step of determining with a device associated with a radio access network at least one interval when a user equipment of the radio access network can at least one of transmit and receive intermittent background traffic associated with at least one of applications and services of the user equipment. At Block 5B there is a step of sending an indication of the at least one interval towards the user equipment.

The method of FIG. 5, where the at least one interval is based on a radio access network configuration.

The method of FIG. 5, and further comprising receiving an indication that the user equipment has intermittent background traffic associated with at least one of applications and services of the user equipment to send to the network, where the at least one interval is sent in response to the received indication.

The method of claim 5, where the assistance information is for use by the user equipment to schedule at least one interval for the data transfer of the intermittent background traffic to optimize battery consumption of the user equipment.

The method of FIG. 5, and further comprising receiving a proposal from the user equipment indicating a suggested range or a value for an interval for transmitting background intermittent traffic, where the at least one interval is based on at least the proposal.

The method of FIG. 5, where the sending comprises sending a plurality of possible intervals towards the user equipment to enable selecting at the user equipment of one of the plurality of intervals.

The method of FIG. 5, and further comprising receiving data from the user equipment, the data comprising an indication that a type of at least part of the data is intermittent background traffic. The method of FIG. 5, where the at least one interval is based at least in part on a subscription associated with the user equipment.

The method of FIG. 5, where the sending is using at least one of radio resource control signaling and medium access control signaling.

The method of FIG. 5, where the sending is using broadcast signaling.

FIG. 6 is a logic flow diagram that illustrates the operation of a method, and a result of execution of computer program instructions at device in a radio access network such as the eNB 12, in accordance with the exemplary embodiments of this invention. In accordance with these exemplary embodiments a method performs, at Block 6A, a step of determining assistance information associated with intermittent background traffic of at least one of applications and services running on user equipment. At Block 6B there is a step of performing an access from an idle state at the indicated interval.

The method of FIG. 6, where the assistance information is based on an activity associated with the at least one of the applications and services running on the user equipment.

The method of FIG. 6, where the assistance information is based on a data transfer delay tolerance associated with the at least one of the applications and services running on the user equipment.

The method of FIG. 6, where the activity indication is based on a type of the background traffic.

The method of FIG. 6, where the assistance information is based on a mobility state of the user equipment.

The method of FIG. 6, where the assistance information comprises an indication of a timer value, where the timer value is based on a data transfer associated with the intermittent background traffic, where a timer with the timer value is to be started when a data transfer associated with the background traffic ends, and where the user equipment is to transfer to an idle state when the timer expires.

The method of FIG. 6 and the paragraph above, where the timer value is for a radio resource control release timer at the user equipment.

The method of FIG. 6, where the assistance information is determined using data received from the user equipment, the data associated with the intermittent background traffic.

A non-transitory computer-readable medium that contains software program instructions, where execution of the software program instructions by at least one data processor results in performance of operations that comprise execution of the method of FIG. 6 and the foregoing several paragraphs descriptive of FIG. 6.

FIG. 7 is a logic flow diagram that illustrates the operation of a method, and a result of execution of computer program instructions, in accordance with the exemplary embodiments of this invention. In accordance with these exemplary embodiments a method performs, at Block 7A, a step of receiving at a user equipment from a radio access network assistance information associated with at least one interval for data transfer of intermittent background traffic of at least one of applications and services running on a user equipment. At Block 7B there is a step of determining, based the assistance information, the at least one interval for the data transfer of the intermittent background traffic.

The method of FIG. 7, where the at least one interval is based on a radio access network configuration.

The method of FIG. 7, where the assistance information is received based on an indication from the user equipment to the radio access network that the user equipment has intermittent background traffic associated with at least one of applications and services running on the user equipment to send to the network.

The method of FIG. 7, where the assistance information is in response to information from the user equipment indicating a suggested range or a value for an interval for transmitting background intermittent traffic associated with the at least one of applications and services running on the user equipment.

The method of FIG. 7, where assistance information from the radio access network comprises an indication of a plurality of possible intervals for the data transfer of the background traffic.

The method of FIG. 7 and the paragraph above, further comprising selecting by the user equipment one of the plurality of possible intervals that is currently best suited for the data transfer of the intermittent background traffic.

The method of FIG. 7, where the determining comprises scheduling the at least one interval for the data transfer of the intermittent background traffic by the user equipment to optimize battery consumption of the user equipment.

The method of FIG. 7, further comprising sending towards the radio access network the intermittent background traffic using the at least one interval for the data transfer of the intermittent background , where the sending comprises indicating to the radio access network that a type of the traffic being transmitted is intermittent background traffic.

The method of FIG. 7, where the assistance information comprises an indication of a timer value, where the timer value is based on a data transfer associated with the intermittent background traffic, the method further comprising: starting a timer with the timer value when a data transfer associated with the background traffic ends; and transferring to an idle state when the timer expires.

The method of FIG. 7, where the timer value is for a radio resource control release timer at the user equipment.

FIG. 8 is a logic flow diagram that illustrates the operation of a method, and a result of execution of computer program instructions, in accordance with the exemplary embodiments of this invention. In accordance with these exemplary embodiments a method performs, at Block 8A, a step of determining assistance information associated with intermittent background traffic of at least one of applications and services running on user equipment. At Block 8B there is a step of sending said assistance information towards a serving network element.

The method of FIG. 8, where the assistance information is based on an activity associated with the at least one of the applications and services running on the user equipment.

The method of FIG. 8, where the assistance information is based on a data transfer delay tolerance associated with the at least one of the applications and services running on the user equipment.

The method of FIG. 8, where the assistance information is based on at least one of a type of traffic and a mobility state of the user equipment.

The method of FIG. 8, where the assistance information is determined by a connection scheduler function.

The method of FIG. 8, further comprising re-configuration of a radio connection with at least one of a discontinuous reception configuration, adaptation of connection release timer and releasing the radio connection.

The method of FIG. 8 and the paragraph above, where the re-configuration minimizes power consumption of the user equipment and minimizes radio network signaling load.

The method of FIG. 8, further comprising receiving signaling at a user equipment from a radio access network, the signaling comprising an indication at least one interval when the user equipment can at least one of transmit and receive the intermittent background traffic. The method of FIG. 8 and the paragraphs above, further comprising selecting with the user equipment an interval of the at least one interval, and performing at least one of an access from an idle state at the selected interval and an initiation of data transfer in a connected state.

The method of FIG. 8 and the paragraphs above, where the indication of the at least one interval is for use by the user equipment to schedule at least one interval for the data transfer

The method of FIG. 8 and the paragraphs above, where the interval is selected by the user equipment based on at least one of the minimization or user equipment power consumption and subscription class.

The method of FIG. 8 and the paragraphs above, where the indication of the at least one interval is based on data provided by the user equipment, the data associated with the intermittent background traffic.

FIG. 9 is a logic flow diagram that illustrates the operation of a method, and a result of execution of computer program instructions, in accordance with the exemplary embodiments of this invention. In accordance with these exemplary embodiments a method performs, at Block 9A, a step of receiving signaling at a user equipment from a radio access network, the signaling indicating an interval when the user equipment can at least one of transmit and receive intermittent background traffic associated with at least one of applications and services running on the user equipment. At Block 9B there is a step of performing an access from an idle state at the indicated interval.

The various blocks shown in FIGS. 4, 5, 6, 7, 8, and/or 9 may be viewed as method steps, and/or as operations that result from operation of computer program code, and/or as a plurality of coupled logic circuit elements constructed to carry out the associated function(s).

The exemplary embodiments also encompass an apparatus that comprises at least one data processor and at least one memory including computer program code. The at least one memory and computer program code are configured, with the at least one data processor, to cause the apparatus at least to receive signaling at a user equipment from a radio access network, the signaling indicating an interval when the user equipment can transmit and/or receive intermittent traffic, and to perform an access from an idle state at the indicated interval.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the UTRAN LTE system, it should be appreciated that the exemplary embodiments of this invention are not limited for use with only this one particular type of wireless communication system, and that they may be used to advantage in other wireless communication systems such as the UTRAN system.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters are not intended to be limiting in any respect, as these parameters may be identified by any suitable names. Further, the various names assigned to different functions and protocol layers (e.g., connection scheduler, MAC, RRC, etc.) are not intended to be limiting in any respect, as these various functions and protocol layers may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof

1.-37. (canceled)

38. A method comprising:
determining assistance information for the radio configuration; and
sending said assistance information towards a serving network element to assist in configuring connected mode discontinuous reception parameters and connection release handling to optimize at least one of power consumption or user experience.

39. The method of claim 38, wherein, the assistance information is for the configuration at least one of a discontinuous reception configuration, adaptation of connection release timer and releasing the radio connection.

40. The method of claim 38, wherein the assistance information is associated with data traffic of at least one of applications and services.

41. The method of claim 40, where the data traffic is intermittent background traffic.

42. The method of claim 38, where the assistance information is based on an activity associated with the at least one of the applications and services.

43. The method of claim 42, where the activity is determined whether the user equipment is being actively used.

44. The method of claim 38, where the assistance information is based on a data transfer delay tolerance associated with the at least one of the applications and services.

45. The method of claim 38, where the assistance information is at least one of a type of traffic, a mobility state, and velocity of a user equipment.

46. The method of claim 38, where the assistance information is determined by a connection scheduler function.

47. The method of claim 38, where the configuration minimizes at least of power consumption or radio network signaling load.

48. The method of claim 38, where the connection release handling is at least one of configuration of the connection release timer or releasing the connection.

49. An apparatus comprising:
at least one processor; and
at least one memory including computer program code, where the at least one memory and the computer program code are configured, with the at least one processor, to cause the apparatus to at least:
determine assistance information for the radio configuration; and
send said assistance information towards a serving network element to assist in configuring connected mode discontinuous reception parameters and connection release handling to optimize at least one of power consumption or user experience.

50. The apparatus of claim 49, wherein, the assistance information is for the configuration at least one of a discontinuous reception configuration, adaptation of connection release timer and releasing the radio connection.

51. The apparatus of claim 49, wherein the assistance information is associated with data traffic of at least one of applications and services.

52. The apparatus of claim 51, where the data traffic is intermittent background traffic.

53. The apparatus of claim 49, where the assistance information is based on an activity associated with the at least one of the applications and services.

54. The method of claim 53, where the activity is determined whether the user equipment is being actively used.

55. The apparatus of claim 49, where the assistance information is based on a data transfer delay tolerance associated with the at least one of the applications and services.

56. The apparatus of claim 49, where the assistance information is at least one of a type of traffic, a mobility state, and velocity of a user equipment.

57. The apparatus of claim 49, where the assistance information is determined by a connection scheduler function.

58. The apparatus of claim 49, where the configuration minimizes at least of power consumption or radio network signaling load.

59. The apparatus of claim 49, where the connection release handling is at least one of configuration of the connection release timer or releasing the connection.
